(19) United States
(12) Patent Application Publication
(10) Pub. No.: US 2020/0095406 A1
(43) Pub. Date: Mar. 26, 2020

(54) HALOGEN-FREE RESIN COMPOSITION AND INSULATION WIRE

(71) Applicant: HITACHI METALS, LTD., Tokyo (JP)

(72) Inventors: Shingo ASHIHARA, Tokyo (JP); Hirotaka YASAKI, Tokyo (JP); Takashi AOYAMA, Tokyo (JP)

(21) Appl. No.: 16/582,451

(22) Filed: Sep. 25, 2019

(30) Foreign Application Priority Data
Sep. 26, 2018 (JP) 2018-180306

(51) Int. Cl. C08L 23/08; C08L 23/26; H01B 7/02; H01B 13/14; H01B 7/295; H01B 3/44

(52) U.S. Cl. CPC C08L 23/0815; C08L 23/0853; C08L 23/26; H01B 7/0275; H01B 13/141; H01B 7/295; C08L 2312/00; C08L 2205/025; C08L 2205/03; C08L 2205/035; C08L 2310/00; C08L 2201/08; C08L 2203/202; H01B 3/441

(57) ABSTRACT

A halogen-free resin composition is disclosed comprising a base polymer. In the halogen-free resin composition, the content of a compound including magnesium is equal to or less than 30 parts by mass relative to 100 parts by mass of the base polymer; and the content of a compound including calcium is equal to or less than 30 parts by mass relative to 100 parts by mass of the base polymer. The halogen-free resin composition has an oxygen index of 20 or more. Preferably, the halogen-free resin composition further includes a heavy metal deactivator. Preferably, the base polymer includes a polymer that has a melting point of 120° C.

### CROSS-REFERENCE TO RELATED APPLICATIONS

The present application claims the benefit of Japanese Patent Application No. 2018-180306 filed on Sep. 26, 2018 with the Japan Patent Office, the entire disclosure of which is incorporated herein by reference.

### BACKGROUND

The present disclosure relates to a halogen-free resin composition and an insulation wire.

An insulation wire disclosed in Japanese Unexamined Patent Application Publication No. 2002-324440 (Patent Document 1) comprises a conductor and an insulation layer. The insulation layer covers the conductor. The insulation layer includes a halogen-free flame retardant, such as magnesium hydroxide and the like.

### SUMMARY

The insulation wire disclosed in Patent Document 1 is placed in a power distribution panel in some cases. In this case, a deliquescence phenomenon may occur. Hereinafter, explanations are given to the deliquescence phenomenon. The power distribution panel defines a closed space therein, which often causes high temperature and high humidity within the power distribution panel. Nitrogen oxide and sulfur oxide present in the power distribution panel reacts with a component included in the insulation layer and as a result, this reaction produces a metal nitrate and a metal sulfate. A liquid droplet of an aqueous solution, which includes the metal nitrate and the metal sulfate, is then precipitated on a surface of the insulation wire.

The aqueous solution including the metal nitrate and the metal sulfate has electrical conductivity. A problem occurs when the aqueous solution is deposited on a terminal contact portion and/or other portions included in a terminal portion of the insulation wire. As a substance that causes occurrence of the deliquescence phenomenon, Patent Document 1 describes magnesium hydroxide included in the insulation layer. In view of this, it is contemplated to reduce a content of magnesium hydroxide in the insulation layer in order to reduce occurrence of the deliquescence phenomenon.

However, the deliquescence phenomenon may occur even if the content of magnesium hydroxide in the insulation layer is reduced. Furthermore, if a content of the flame retardant in the insulation layer is excessively insufficient, flame retardancy decreases.

In a first aspect of the present disclosure, it is desirable to provide a halogen-free resin composition and an insulation wire that can reduce occurrence of the deliquescence phenomenon and has sufficient flame retardancy.

In the first aspect of the present disclosure, provided is a halogen-free resin composition that comprises a base polymer. In the halogen-free resin composition, the content of a compound including magnesium is equal to or less than 30 parts by mass relative to 100 parts by mass of the base polymer; and the content of a compound including calcium is equal to or less than 30 parts by mass relative to 100 parts by mass of the base polymer. The halogen-free resin composition has an oxygen index of 20 or more.

With the halogen-free resin composition of the first aspect of the present disclosure, respective contents of both the compound including magnesium and the compound including calcium are reduced, thus reducing occurrence of the deliquescence phenomenon. Further, the halogen-free resin composition of the first aspect of the present disclosure has an oxygen index of 20 or more and therefore has sufficient flame retardancy.

With an insulation wire of a second aspect of the present disclosure that comprises an insulation layer, at least a portion of the insulation layer includes the halogen-free resin composition of the first aspect of the present disclosure, thus reducing occurrence of the deliquescence phenomenon.

Furthermore, the halogen-free resin composition, which forms the insulation layer, has an oxygen index of 20 or more. Therefore, the insulation wire of the second aspect of the present disclosure has sufficient flame retardancy.

### BRIEF DESCRIPTION OF THE DRAWINGS

An example embodiment of the present disclosure will be described hereinafter with reference to the accompanying drawings, in which:

FIG. 1 is a sectional view showing a configuration of an insulation wire;

FIG. 2 is a sectional view showing a configuration of the insulation wire; and

FIG. 3 is an explanatory diagram showing a method of manufacturing the insulation wire using an extruder.

### DETAILED DESCRIPTION OF EXEMPLARY EMBODIMENTS

### 1. HALOGEN-FREE RESIN COMPOSITION

A halogen-free resin composition of the present disclosure includes a base polymer. The base polymer can be appropriately selected, for example, from polymers that have hydrocarbons in molecular frameworks or molecular side chains. The base polymer includes, for example, the following polymers (a) to (d).

The polymer (a) is polyethylene, polypropylene, an ethylene-propylene-diene copolymer, an ethylene-α olefin copolymer, an ethylene-vinyl acetate copolymer, an ethylene-acrylic ester copolymer, and the like.

The α olefin used herein is butene, propylene, octene, and the like. Further, polyethylene is, for example, high-density polyethylene (HDPE), low-density polyethylene (LDPE), linear low-density polyethylene (LLDPE), very low-density polyethylene (VLDPE), and the like.

The polymer (b) is a modified product of one or more kinds of the polymer (a). The modified product is, for example, a copolymerized silane compound or a grafted silane compound, a maleic acid-modified product, and the like.

The polymer (c) is a terpolymer, in which another monomer is further added to one or more kinds of the polymer (a) or the polymer (b).

The polymer (d) is a mixture of two or more kinds of polymers selected from the polymers (a) to (c).

Preferably, the base polymer includes a polymer that has a melting point greater than 120° C. In this case, thermal deformation resistance of the halogen-free resin composition further increases. The polymer having a melting point greater than 120° C. is, for example, a crystalline polymer. The crystalline polymer is not particularly limited in its kind, melting point, content, and the like. The melting point means a peak temperature of melting in DSC (Differential Scanning Calorimetry). The temperature of 120° C. corresponds to a temperature based on a thermal deformation test.

In the halogen-free resin composition of the present disclosure, the content of a compound including magnesium is equal to or less than 30 parts by mass relative to 100 parts by mass of the base polymer. Further, the content of a compound including calcium is equal to or less than 30 parts by mass relative to 100 parts by mass of the base polymer.

The content of the compound including magnesium is not particularly limited in the lower limit. However, the content of the compound including magnesium is preferably equal to or more than 0 parts by mass or is equal to or more than 5 parts by mass relative to 100 parts by mass of the base polymer. The content of the compound including calcium is not particularly limited in the lower limit. However, the content of the compound including calcium is preferably equal to or more than 0 parts by mass, or is equal to or more than 5 parts by mass relative to 100 parts by mass of the base polymer.

The compound including magnesium and the compound including calcium react with NO₂ and/or SO₂ and then causes a deliquescence phenomenon. The halogen-free resin composition of the present disclosure has respectively reduced contents of the compound including magnesium and the compound including the calcium, thus hardly causing the deliquescence phenomenon.

The compound including magnesium is, for example, magnesium hydroxide and the like. Magnesium hydroxide can be blended into the halogen-free resin composition of the present disclosure as a flame retardant.

The compound including calcium is, for example, calcium carbonate and the like. The calcium carbonate can be blended into the halogen-free resin composition of the present disclosure as a filler. Blending of calcium carbonate enables reduction in material cost incurred for the halogen-free resin composition of the present disclosure.

Preferably, the halogen-free resin composition of the present disclosure includes reduced contents of respective compounds that include metallic elements classified in the Group 1 and the Group 2 of the element periodic table (hereinafter referred to as a Group 1 compound and a Group 2 compound). The Group 1 compound and the Group 2 compound cause the deliquescence phenomenon. If the halogen-free resin composition of the present disclosure includes the respective reduced contents of the Group 1 compound and the Group 2 compound, the deliquescence phenomenon further hardly occurs.

The halogen-free resin composition of the present disclosure has an oxygen index of 20 or more and therefore, the halogen-free resin composition of the present disclosure has sufficient flame retardancy. The oxygen index shows combustion characteristics of a material. The oxygen index of the halogen-free resin composition of the present disclosure can be increased by increasing a content of the halogen-free flame retardant, such as metal hydroxide.

The halogen-free resin composition of the present disclosure can be formulated with an antioxidant, another flame retardant, a flame retardant aid, process oil, lubricant, an ultraviolet absorber, another filler, a reinforcing agent, a copper inhibitor, a cross-linking auxiliary agent, radiation absorbing agent, anti-ozone degradation agent, or a compatibilizer.

Preferably, the halogen-free resin composition of the present disclosure additionally includes a heavy metal deactivator. If the heavy metal deactivator is additionally included, metal derived from a conductor is diffused into the halogen-free resin composition, which enables reduction of a phenomenon that degrades the halogen-free resin composition. Metal derived from the conductor is, for example, copper and the like. The heavy metal deactivator may be a commonly used heavy metal deactivator, such as CAS-No.63245-38-5, 32687-78-8, 36411-52-6, and the like, for example. Preferably, the heavy metal deactivator can capture copper ions.

The halogen-free resin composition of the present disclosure has a hue of, for example, black, yellow, or green. The hue of the halogen-free resin composition of the present disclosure can be set by, for example, including a color master batch, into which a pigment corresponding to a desired hue is blended in high concentration, in a raw material of the halogen-free resin composition of the present disclosure. The pigment can be appropriately selected from halogen element-free pigments. A base polymer of the master batch can be appropriately selected from halogen element-free polymers.

If the hue is set to be black, the pigment for use can be, for example, carbon black, acetylene black, lamp black, bone black, graphite, iron black, aniline black, cyanine black, mineral black, or the like.

If the hue is set to be yellow, the pigment for use can be, for example, a yellow pigment alone. The yellow pigment is, for example, an inorganic pigment, such as chrome yellow, zinc yellow, barium chromate, cadmium yellow, ochre, and titanium yellow, and an organic pigment, such as a nitro-based pigment and an azo-containing pigment. The azo-containing pigment is, for example, a mono-azo pigment, a disazo-pigment, a condensed azo pigment and the like. Further, if the hue is set to be yellow, the pigment for use can be a mixture of the yellow pigment and a red pigment. The red pigment is, for example, an inorganic pigment, such as a Bengala pigment and a red lead pigment, and an organic pigment, such as the azo-containing pigment and a quinacridone pigment.

If the hue is set to be green, the pigment for use can be, for example, a green pigment alone. The green pigment is, for example, an inorganic pigment, such as a chrome green pigment and a cobalt green pigment, and an organic pigment such as a nitroso-containing pigment. Further, if the hue is set to be green, the pigment for use can be a mixture of a blue pigment such as phthalocyanine blue and the yellow pigment such as the azo-containing pigment or the red pigment.

The antioxidant is, for example, phenol-based antioxidant, amine-based antioxidant, sulfur-based antioxidant, phosphite ester-based antioxidant, and the like. The cross-linking auxiliary agent is, for example, trimethylol propane trimethacrylate, triallyl isocyanurate, triallyl cyanurate, N, N′-meta-phenylene bismaleimide, ethylene glycol dimethacrylate, zinc acrylate, zinc methacrylate, and the like. Further, the lubricant is, for example, a fatty acid amide-based lubricant, a fatty acid-based lubricant, a hydrocarbon-based lubricant, an ester-based lubricant, an alcohol-based lubricant, metallic soup-based lubricant, and the like.

### 2. INSULATION WIRE

An insulation wire of the present disclosure comprises an insulation layer. The insulation layer covers the conductor. At least a portion of the insulation layer comprises the halogen-free resin composition of the present disclosure. Therefore, the deliquescence phenomenon can hardly occur with the insulation wire of the present disclosure. Further, the insulation wire of the present disclosure has sufficient flame retardancy.

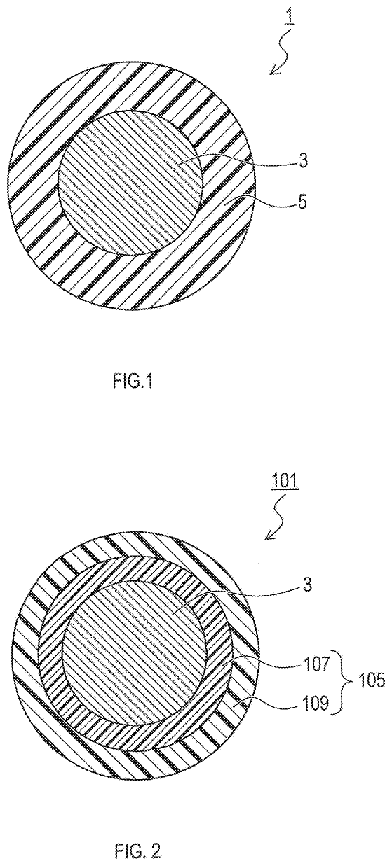

The insulation wire of the present disclosure has, for example, a configuration shown in FIG. 1. An insulation wire 1 comprises a conductor 3 and an insulation layer 5. The conductor 3 is covered with the insulation layer 5. The insulation layer 5 comprises the halogen-free resin composition of the present disclosure.

The conductor may be a commonly used metal wire. The metal wire is, for example, a copper wire, a copper alloy wire, an aluminum wire, a gold wire, a silver wire, and the like. Further, the conductor for use may be formed such that the metal wire is plated thereover with metal, such as tin, nickel, or the like. Still further, the conductor for use may be a twisted wire formed by twisting metal wires.

The insulation layer comprises, for example, two or more layers. If the insulation layer comprises the two or more layers, then the insulation wire of the present disclosure has, for example, a configuration shown in FIG. 2. An insulation wire 101 comprises the conductor 3 and an insulation layer 105. The insulation layer 105 comprises an inner layer 107 and an outer layer 109.

Of the two or more layers, at least the outermost layer comprises the halogen-free resin composition of the present disclosure. In the case of the insulation wire 101 shown in FIG. 2, at least the outer layer 109 comprises the halogen-free resin composition of the present disclosure.

The deliquescence phenomenon generally occurs on an outer surface of the insulation wire. If the outermost layer of the two or more layers comprises the halogen-free resin composition of the present disclosure, then it is possible to further reduce occurrence of the deliquescence phenomenon.

The other layer or layers other than the outermost layer of the two or more layers may comprise the halogen-free resin composition of the present disclosure or another material. A thickness of the two or more layers can be appropriately set. The other layer or the layers other than the outermost layer may have the same hue as in the outermost layer or have different hue.

The two or more layers can be formed, for example, such that an inner layer is first prepared by extrusion covering and an outer layer is thereafter prepared by the extrusion covering. Further, the two or more layers may be formed in a manner to be prepared concurrently by the extrusion covering. Preferably, the halogen-free resin composition, which forms at least a portion of the insulation layer, is a cross-linked product. If the halogen-free resin composition is a cross-linked product, the insulation layer has enhanced thermal deformation resistance.

The halogen-free resin composition is crossed-linked by a method that is appropriately selected from publicly known cross-linking methods. Preferably, the method of cross-linking the halogen-free resin composition is a method that does not require pressurization. The method without pressurization is, for example, cross-linking by electron beam irradiation, silane cross-linking, thermal cross-linking using molten salt, infrared radiation cross-linking, and the like.

If the method without pressurization is used, then it is possible to inhibit the insulation layer from deeply sinking into the conductor. Consequently, this facilitates removal of the insulation layer in terminal processing. Additionally, it is possible to reduce occurrence of outer diameter defect in the insulation wire.

The insulation wire of the present disclosure is used, for example, to be placed in a power distribution panel. The power distribution panel is not limited in its specification and size. The power distribution panel defines a closed space therein, which causes high temperature and high humidity within the power distribution panel in some cases. In this case, in general, the deliquescence phenomenon is likely to occur. Further, narrow-space wiring is made in the power distribution panel. If there exists a possibility where a person directly contacts the power distribution panel, a risk of electrification increases upon occurrence of the deliquescence phenomenon on a surface of the insulation wire. Using the insulation wire of the present disclosure can reduce the deliquescence phenomenon and therefore, the risk of electrification can be reduced.

Preferably, the conductor and the insulation layer do not interpose a releasing layer such as a separator tape therebetween. The insulation wire without the releasing layer has further enhanced flexibility.

### 3. EXAMPLES

(3-1) Halogen-Free Resin Composition

Halogen-free resin compositions according to Examples 1 to 14 and Comparative Examples 1 to 3 were manufactured in accordance with blending shown in Tables 1 and 2. A method of manufacturing the halogen-free resin composition includes mixing and kneading by a kneader mixer that has an inner volume of 55 L and shaping the halogen-free resin composition into a pellet.

TABLE 1
(Unit of blending amount: parts by mass)

| | | | Comparative | Example | Comparative | Example | Example | Example | Comparative | Example |
|---|---|---|---|---|---|---|---|---|---|---|
| Item | | | Example 1 | 1 | Example 2 | 2 | 3 | 4 | Example 3 | 5 |
| Halogen- | Polymer | Ethylene-α | 40 | 40 | 40 | 40 | 40 | 40 | 40 | 40 |
| free resin | | olefin | | | | | | | | |
| composition | | copolymer*¹ | | | | | | | | |
| | | Ethylene-vinyl | 40 | 40 | 40 | 40 | 40 | 40 | 40 | 40 |
| | | acetate | | | | | | | | |
| | | copolymer A*² | | | | | | | | |
| | | Ethylene-vinyl | 20 | 20 | 20 | 20 | 20 | 20 | 20 | 20 |
| | | acetate | | | | | | | | |
| | | copolymer B*³ | | | | | | | | |
| | | High density | | | | | | | | |
| | | polyethylene*⁴ | | | | | | | | |
| | | Silane-grafted | | | | | | | | |
| | | ehylene vinyl | | | | | | | | |
| | | acetate | | | | | | | | |
| | | copolymer *⁵ | | | | | | | | |
| | Cross- | Trimethylol | 2 | 2 | 2 | 2 | 2 | 2 | 2 | 2 |
| | linking | propane | | | | | | | | |
| | auxiliary | trimethacrylate | | | | | | | | |
| | agent | | | | | | | | | |
| | Antioxidant | Phenol-based | 0.6 | 0.6 | 0.6 | 0.6 | 0.6 | 0.6 | 0.6 | 0.6 |
| | | antioxidant | | | | | | | | |
| | | Sulfur-based | 1.2 | 1.2 | 1.2 | 1.2 | 1.2 | 1.2 | 1.2 | 1.2 |
| | | Antioxidant | | | | | | | | |
| | Copper | Heavy metal | 0.5 | 0.5 | 0.5 | 0.5 | 0.5 | 0.5 | 0.5 | 0.5 |
| | inhibitor | deactivator | | | | | | | | |
| | Lubricant | Amide-based | 1 | 1 | 1 | 1 | 1 | 1 | 1 | 1 |
| | | lubricant | | | | | | | | |
| | Flame | Magnesium | 20 | 30 | 40 | 20 | | | | |
| | retardant | hydroxide*⁶ | | | | | | | | |
| | | Aluminum | | | | 50 | 50 | 50 | 50 | 50 |
| | | hydroxide*⁷ | | | | | | | | |
| | Filler | Calcium | | | | | | 30 | 40 | 30 |
| | | carbonate*⁸ | | | | | | | | |
| | Pigment | Carbon black*⁹ | 5 | 5 | 5 | 5 | 5 | 5 | 5 | |
| | | Color master | | | | | | | | 5 |
| | | batch (Yellow)*¹⁰ | | | | | | | | |
| | | Color master | | | | | | | | |
| | | batch (Green)*¹¹ | | | | | | | | |
| | Others | Master batch | | | | | | | | |
| | | with silanol | | | | | | | | |
| | | condensation | | | | | | | | |
| | | catalyst*¹² | | | | | | | | |
| Irradiation dose of electron beam [Mrad] | | | 10 | 10 | 10 | 10 | 10 | 10 | 10 | 10 |
| Evaluation | Character- | Deliquescence | ∘ (N) | ∘ (N) | x (Y) | ∘ (N) | ∘ (N) | ∘ (N) | x (Y) | ∘ (N) |
| | istics | Oxygen index | x (19.8) | ∘ (22.4) | ∘ (23.2) | ∘ (24.9) | ∘ (22.9) | ∘ (22.5) | ∘ (22.1) | ∘ (22.4) |
| | | Degree of cross- | 75 | 76 | 84 | 87 | 84 | 87 | 88 | 86 |
| | | linking | | | | | | | | |
| | | Thermal | 23.1 | 22.2 | 20.9 | 18.3 | 19.7 | 18.1 | 17.8 | 19.5 |
| | | deformation rate | | | | | | | | |
| | | [%] | | | | | | | | |
| | | Electric wire | N | N | N | N | N | N | N | N |
| | | winding test after | | | | | | | | |
| | | application of | | | | | | | | |
| | | heating | | | | | | | | |

| | | | | | | | | |
|---|---|---|---|---|---|---|---|---|
| Overall determination | x | ∘ | x | ∘ | ∘ | ∘ | x | ∘ |

TABLE 2
(Unit of blending amount: parts by mass)

| | | | Exam- | Exam- | Exam- | Exam- | Exam- | Exam- | Exam- | Exam- | Exam- |
|---|---|---|---|---|---|---|---|---|---|---|---|
| Item | | | ple 6 | ple 7 | ple 8 | ple 9 | ple 10 | ple 11 | ple 12 | ple 13 | ple 14 |
| Halogen- | Polymer | Ethylene-α | 40 | 40 | 40 | | | | | 40 | 40 |
| free resin | | olefin | | | | | | | | | |
| composition | | copolymer*¹ | | | | | | | | | |
| | | Ethylene-vinyl | 40 | 40 | 30 | | | | | 40 | 40 |
| | | acetate | | | | | | | | | |
| | | copolymer A*² | | | | | | | | | |
| | | Ethylene-vinyl | 20 | 20 | 10 | | | | | 20 | 20 |
| | | acetate | | | | | | | | | |
| | | copolymer B*³ | | | | | | | | | |
| | | High density | | | 20 | | | | 20 | | |
| | | polyethylene*⁴ | | | | | | | | | |
| | | Silane-grafted | | | | 100 | 100 | 100 | 80 | | |
| | | ehylene vinyl | | | | | | | | | |
| | | acetate | | | | | | | | | |
| | | copolymer *⁵ | | | | | | | | | |
| | Cross- | Trimethylol | 2 | 2 | 2 | | | | | 2 | 2 |
| | linking | propane | | | | | | | | | |
| | auxiliary | trimethacrylate | | | | | | | | | |
| | agent | | | | | | | | | | |
| | Antioxidant | Phenol-based | 0.6 | 0.6 | 0.6 | | | | | 0.6 | 0.6 |
| | | antioxidant | | | | | | | | | |
| | | Sulfur-based | 1.2 | 1.2 | 1.2 | 1.2 | 1.2 | 1.2 | 1.2 | 1.2 | 1.2 |
| | | antioxidant | | | | | | | | | |
| | Copper | Heavy metal | 0.5 | 0.5 | 0.5 | | | | | 0.5 | 0.5 |
| | inhibitor | deactivator | | | | | | | | | |
| | Lubricant | Amide-based | 1 | 1 | 1 | 1 | 1 | 1 | 1 | 1 | 1 |
| | | lubricant | | | | | | | | | |
| | Flame | Magnesium | | | | | 30 | | | 5 | |
| | retardant | hydroxide*⁶ | | | | | | | | | |
| | | Aluminum | 50 | 50 | 50 | 50 | | 50 | 50 | 50 | 50 |
| | | hydroxide*⁷ | | | | | | | | | |
| | Filler | Calcium | 30 | 30 | 30 | 30 | | | 30 | | 5 |
| | | carbonate*⁸ | | | | | | | | | |
| | Pigment | Carbon black*⁹ | | | | | | | | | |
| | | Color master | | 5 | 5 | 5 | 5 | 5 | 5 | | |
| | | batch (Yellow)*¹⁰ | | | | | | | | | |
| | | Color master | 5 | | | | | | | | |
| | | batch (Green)*¹¹ | | | | | | | | | |
| | Other | Cross-linking | | | | 5 | 5 | 5 | 5 | | |
| | | catalyst · | | | | | | | | | |
| | | Antioxidant | | | | | | | | | |
| | | master batch*¹² | | | | | | | | | |
| Irradiation dose of electron beam [Mrad] | | | 10 | — | 10 | — | — | — | — | 10 | 10 |
| Evaluation | Character- | Deliquescence | ∘ (N) | ∘ (N) | ∘ (N) | ∘ (N) | ∘ (N) | ∘ (N) | ∘ (N) | ∘ | ∘ |
| | istics | Oxygen index | ∘ (22.3) | ∘ (21.6) | ∘ (21.8) | ∘ (24.4) | ∘ (23.6) | ∘ (24.8) | ∘ (21.9) | ∘ (23.2) | ∘ (22.8) |
| | | Degree of cross-linking | 84 | 0 | 73 | 59 | 55 | 57 | 51 | 85 | 85 |
| | | Thermal deformation rate | 19.9 | 74.5 | 13.5 | 29.2 | 31.3 | 29.9 | 22.6 | 19.4 | 19.3 |
| | | [%] | | | | | | | | | |
| | | Electric wire winding test | N | N | N | N | N | N | N | N | N |
| | | after application of heating | | | | | | | | | |

| | | | | | | | | | |
|---|---|---|---|---|---|---|---|---|---|
| Overall determination | ∘ | ∘ | ∘ | ∘ | ∘ | ∘ | ∘ | ∘ | ∘ |

In the case of blending where a silane-grafted material is included, a dry blend of a cross-linking catalyst and a master batch containing antioxidant is prepared separately from the silane-grafted material so that the cross-linking catalyst and the master batch are blended at a specified ratio. Then, this dry blend was supplied to a single-shaft extruder when the insulation layer is formed as mentioned below.

Blending components in the above Tables 1 and 2 are detailed below.

*1: Ethylene-butene copolymer has a MFR of 3.6 (g/10 min at 190° C. under a load of 2.16 kgf) and a melting point of 66° C.

*2: A content of vinyl acetate is 15 percent by mass and ethylene-vinyl acetate copolymer has a MFR of 0.8 (g/10 min at 190° C. under a load of 2.16 kgf) and a melting point of 89° C.

*3: A content of vinyl acetate is 28 percent by mass and ethylene-vinyl acetate copolymer has a MFR of 6.0 (g/10 min at 190° C. under a load of 2.16 kgf) and a melting point of 72° C.

*4: High density polyethylene has a density of 0.951 g/cm³, a MFR of 0.8 (g/10 min at 190° C. under a load of 2.16 kgf), and a melting point of 130° C.

*5: Silane-grafted ethylene vinyl acetate copolymer is LINKLON XVF600N manufactured by Mitsubishi Chemical Corporation.

*6 to 8: All products are surface-treated with a fatty acid.

*9: Thermal carbon having an average particle diameter of 80 nm.

*10: Master batch containing the condensed azo-containing pigment.

*11: Master batch with blending of phthalocyanine blue-based pigment and mono-azo yellow-based pigment.

*12: Master batch with blending of 1 percent by mass of dioctyltin dineodecanoate, 12 percent by mass of phenol-based antioxidant, and 10 percent by mass of heavy metal deactivator.

(3-2) Manufacture of Insulation Wire

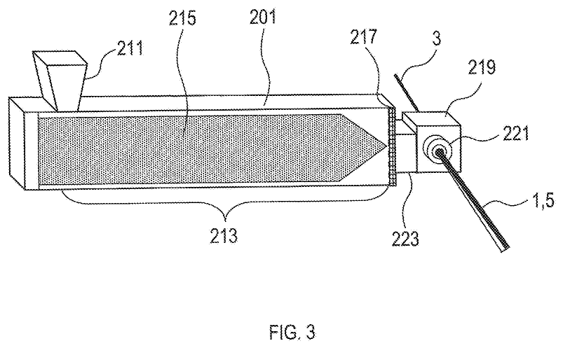

The halogen-free resin compositions according to respective Examples and respective Comparative Examples were used to form the insulation layer for the insulation wire. Specifically, a single-shaft extruder 201 shown in FIG. 3 was used to perform extrusion coating directly over the conductor 3 and the insulation layer 5 was then formed. The single-shaft extruder 201 comprises a hopper 211, a cylinder 213, a screw 215, a breaker plate 217, a cross head 219, dies 221, and a neck 223.

The single-shaft extruder 201 has a screw diameter of 90 mm. The conductor 3 is a copper twisted wire that is plated with tin. The conductor 3 has a cross-section area of 100 mm². The insulation layer 5 has a thickness of 2 mm. Condition in the extrusion coating is shown in Table 3.

TABLE 3

| Classification | Item | Setting |
|---|---|---|
| Extruder | Size | 90 mm Single shaft |
| | L/D | 20 |
| Temperature (° C.) | Cylinder 1 (situated closer to | 120 |
| | hopper) | |
| | Cylinder 2 | 125 |
| | Cylinder 3 | 130 |
| | Cylinder 4 | 135 |
| | Cylinder 5 | 140 |
| | Neck | 160 |
| | Cross head | 160 |
| | Dies | 160 |
| Screw | Rotational speed (rpm) | 50 |
| | Shape | Full flight |
| Taking-up | Take-up speed (m/mi) | 50 |

Accordingly, the insulation wire 1 having the configuration shown in FIG. 1 was obtained through the above processes. After the extrusion coating is applied, cross-linking was performed for the insulation layer. In cross-linking applied for the insulation layer including the silane-grafted material, the insulation layer is stored for 24 hours in the atmosphere of saturated water vapor at a temperature of 60° C. In cross-linking applied for insulation layers other than the insulation layer including the silane-grafted material, these insulation layers are irradiated with an electron beam to obtain an irradiation dose of 10 Mrad. In the case of the Example 7, however, the cross-linking was not applied.

(3-3) Method of Evaluating Halogen-Free Resin Composition and Insulation Wire

The halogen-free resin compositions according to the respective Examples and the respective Comparative Examples were each evaluated by the following methods.

<Evaluation on Deliquescence>

A desiccator having an inner volume of 3 L was prepared and 15 mL of 10 percent nitric acid was placed in the bottom of the desiccator. Thereafter, a cut insulation wire having a length of 50 mm was placed in the desiccator and was sealed therein. The cut insulation wire was stored under a temperature of 40° C. for 8 hours in a sealed manner.

After 8 hours passed from initiation of storage in the desiccator, concentration of nitrogen dioxide within the desiccator was measured by a detection tube. The concentration of nitrogen dioxide was approximately 14 ppm. According to JIS C60721-3-3 (Classification of Environmental Conditions [3C4]), the maximum level of nitrogen oxides in stationary use at weather-protected locations is 20 mg/m³ (approximately 10 ppm). Thus, environment within the desiccator corresponds to the environmental condition for placing the insulation wire in the power distribution panel.

After 8 hours passed from the initiation of storage in the desiccator, the cut insulation wire was removed from the desiccator and was left in a petri plate for 16 hours. Here, the petri plate had a piece of gauze placed therein, which was sufficiently moistened with distilled water. This elevated humidity in the petri plate. A temperature in the petri plate was a room temperature.

A surface of the cut insulation wire was visually observed after being left and presence of a liquid droplet (deliquescent substance) was confirmed. The Example or a Comparative example, in which the liquid droplet was not visible, was given a pass “∘” and the Example or a Comparative example, in which the liquid droplet was visible, was given a fail “×”. The result of evaluation is shown in the above Tables 1 and 2.

<Oxygen Index>

The halogen-free resin composition was formed into a piece of sheet having a thickness of 3 mm after kneading and mixing was applied. The formation of the halogen-free resin composition was performed at 160° C. Thereafter, the piece of sheet was cross-linked. A method of cross-linking the piece of sheet is the same cross-linking method applied to the insulation layer in manufacturing the insulation wire.

The oxygen index was measured with respect to the piece of sheet after the cross-linking was applied by using OXYGEN INDEXER manufactured by Toyo Seiki Seisaku-sho, Ltd. by a method in accordance with JIS K7201-2 (2007). The Example or a Comparative Example, in which the oxygen index was 20 or more, was given a pass “∘” and the Example or a Comparative Example, in which the oxygen index of less than 20, was given a fail “×”. The result of evaluation is shown in Tables 1 and 2.

<Degree of Cross-Linking>

A sample having a weight of 0.5 g was taken from the halogen-free resin composition. The sample was placed in a brass wire net having 40-mesh in size and was then extracted with xylene in an oil bath at a temperature of 110° C. for 24 hours. Then, the sample was naturally dried through the night and was further vacuum-dried at a temperature of 80° C. for 4 hours. Thereafter, the sample was weighted in mass.

The following formula (1) was used to calculate a gel fraction. The gel fraction is an index that shows the cross-linking degree.

gel fraction=(b−a×(z/x))/(a×(y/x))×100 Formula (1):

The following explains meanings of respective letters appearing in Formula (1).

a: a prepared mass (g)

b: an extracted and dried mass (g)

x: a total blended amount (parts by mass)

y: a blending amount of a polymer (parts by mass)

z: a sum blended amount of magnesium hydroxide, aluminum hydroxide, and calcium carbonate (parts by mass)

Here, magnesium hydroxide, aluminum hydroxide, and calcium carbonate were insoluble contents in xylene in calculating the gel fraction. The insoluble contents in xylene were not included in a gel content.

<Thermal Deformation Rate>

The insulation layer was removed from the insulation wire after the cross-linking was applied. Then, an inner surface of the removed insulation layer, which is situated closer to the conductor than an outer surface of the removed insulation layer is, was ground to eliminate roughness. A piece of sample was thereby prepared. The thermal deformation test was conducted by using a thermal deformation tester TM-1515 manufactured by Ueshima Seisakusho Co., Ltd. under conditions having a temperature of 120° C., 30 minutes of pre-heating, and 30 minutes of pressure at 25N. Based on respective thicknesses of the piece of sample before and after the test was conducted, the following Formula (2) was used to calculate a thermal deformation rate.

a thermal deformation rate (%)=(c/d)×100 Formula (2):

In Formula (2), the letter c is the thickness (mm) of the piece of sample after the test was conducted. The letter d is the thickness (mm) of the piece of sample before the test was conducted.

<Electric Wire Winding Test after Application of Heating>

The insulation wire was heated at a temperature of 150° C. for 168 hours after the cross-linking was applied. The insulation wire was left for 24 hours at room temperature after the heating is applied. The heated insulation wire was left for 24 hours at room temperature. Thereafter, the insulation wire was closely wound around a metal mandrel 3 times. Here, the metal mandrel has the same diameter as the diameter of the insulation wire. Presence of a crack (narrow break) in a surface of the insulation wire was confirmed by visual observation. The presence of the crack is influenced by deterioration of the insulation layer caused by copper.

<Overall Determination>

The Example or a Comparative Example, in which the pass was given in both the evaluations of the deliquescence and the oxygen index, was given a pass “∘”; and the Example or a Comparative Example, in which the fail was given in respect of even one item, was given a fail “×”. Results of overall determination are shown in the above Tables 1 and 2.

(3-4) Evaluation Results

In each Example, occurrence of the deliquescence phenomenon could be reduced by reducing respective blending amounts of magnesium hydroxide and calcium carbonate in the halogen-free resin composition. Further, in each Example, a targeted oxygen index could be obtained by blending an appropriate amount of magnesium hydroxide and/or an appropriate amount of aluminum hydroxide into the halogen-free resin composition and therefore, the halogen-free resin composition was confirmed to have sufficient flame retardancy.

Additionally, each Example had an advantageous evaluation result regardless of what hue the halogen-free resin composition has among black, yellow, or green. The Examples 1 to 6 and 8 to 14 underwent the cross-linking for the insulation layer. As a result, the Examples 1 to 6 and 8 to 14 had a reduced thermal deformation rate in comparison with the Example 7, in which the cross-linking was not applied. The base polymer of the Example 8 includes a polymer that has a melting point of 120° C. and therefore, the Example 8 had a more advantageous evaluation result in the thermal deformation test.

The Comparative Example 1 showed a decrease in the oxygen index due to an excessively reduced blending amount of the flame retardant in the halogen-free resin composition. The Comparative Example 2 had occurrence of the deliquescence phenomenon due to an excessively increased blending amount of magnesium hydroxide in the halogen-free resin composition.

The Comparative Example 3, in which the non-halogen resin did not include magnesium hydroxide, had occurrence of the deliquescence phenomenon due to an excessively increased blending amount of calcium carbonate in the halogen-free resin composition.

### 4. OTHER EXAMPLES

Accordingly, examples of the present disclosure have been described. Nevertheless, the present disclosure is not limited to the above examples and may be achieved in various modifications.

(1) In the Examples, a kneading and mixing device other than the kneader mixer may be used to perform kneading and mixing. The kneading and mixing device is, for example, an extruder, a mixer, an autoclave, and the like. Further, it is possible to appropriately set an extrusion condition and a cross-linking condition in the Examples.

(2) Functions of one element in the aforementioned examples may be divided and achieved by two or more elements. Functions of two or more elements may be achieved by one element. A part of the configuration of the aforementioned examples may be omitted. At least a part of the configuration of the aforementioned examples may be added to or replaced with another configuration of the aforementioned examples. It should be noted that any and all modes that are encompassed in the technical ideas that are defined by the language of the claims are examples of the present disclosure.

(3) Other than the aforementioned halogen-free resin composition and the insulation wire, the present disclosure may also be achieved in various other forms, such as a cable, a method of manufacturing a halogen-free resin composition, a method of manufacturing an insulation wire, a method of forming an insulation layer, or the like.

What is claimed is:

1. A halogen-free resin composition, comprising:
a base polymer,
wherein the content of a compound including magnesium is equal to or less than 30 parts by mass relative to 100 parts by mass of the base polymer,
wherein the content of a compound including calcium is equal to or less than 30 parts by mass relative to 100 parts by mass of the base polymer, and
wherein the halogen-free resin composition has an oxygen index of 20 or more.

2. The halogen-free resin composition according to claim 1,
wherein the halogen-free resin composition further includes a heavy metal deactivator.

3. The halogen-free resin composition according to claim 1,
wherein the base polymer includes a polymer that has a melting point greater than 120° C.

4. The halogen-free resin composition according to claim 1,
wherein the hue of the halogen-free resin composition is black, yellow, or green.

5. The halogen-free resin composition according to claim 1,
wherein the content of the compound including calcium is equal to or more than 5 parts by mass relative to 100 parts by mass of the base polymer.

6. The halogen-free resin composition according to claim 1,
wherein the content of the compound including magnesium is equal to or more than 5 parts by mass relative to 100 parts by mass of the base polymer.

7. The halogen-free resin composition according to claim 1,
wherein the halogen-free resin composition further includes aluminum hydroxide.

8. An insulation wire, comprising:
an insulation layer,
wherein at least a portion of the insulation layer includes a halogen-free resin composition,
wherein the halogen-free resin composition includes a base polymer,
wherein, in the halogen-free resin composition, the content of a compound including magnesium is equal to or less than 30 parts by mass relative to 100 parts by mass of the base polymer and the content of a compound including calcium is equal to or less than 30 parts by mass relative to 100 parts by mass of the base polymer,
wherein the halogen-free resin composition has an oxygen index of 20 or more, and
wherein the halogen-free resin composition is cross-linked.

9. The insulation wire according to claim 8,
wherein the insulation layer comprises two or more layers, and
wherein at least the outermost layer of the two or more layers includes the halogen-free resin composition.

10. The insulation wire according to claim 8,
wherein the insulation wire is used for placement in a power distribution panel.
